(19) United States
(12) Patent Application Publication
(10) Pub. No.: US 2005/0229152 A1
(43) Pub. Date: Oct. 13, 2005

(54) Integrated modeling environment

(76) Inventors: Brian Connell, Ottawa (CA); Greg Wilbur, Ottawa (CA); John Afaganis, Saskatchewan (CA); Ian MacFarlane, Stittsville (CA); Lori-Ann McGrath, Kanata (CA)

Correspondence Address: CHRISTOPHER & WEISBERG, P.A., 200 EAST LAS OLAS BOULEVARD, SUITE 2040, FORT LAUDERDALE, FL, 33301, US

(21) Appl. No.: 10/820,295

(22) Filed: Apr. 8, 2004

(51) Int. Cl. G06F 9/44

(52) U.S. Cl. 717/104; 717/137; 717/106

(57) ABSTRACT

In one aspect, a system and method includes modeling in a common representation network element commands, events and data from a plurality of sources. The method also includes translating data represented in a first modeling language to data represented in a second modeling language for storing the data in the second modeling language in a global data model repository and automatically generating code to support external management interface based on the stored data in the global repository.

### BACKGROUND

A network element may gather network element data at run-time data from multiple components or software processes that comprise the network element. The network element data may include configuration data, operational run-time data, or event data. The network element data is managed and reported through commands and events that may be used by multiple element management systems for provisioning, maintenance or billing of service of the network element. The commands, events and data used to manage the network element are provided to network operators for management systems in the form of system documentation.

### SUMMARY

In one aspect, a method includes modeling in a common representation network element commands, events and data from a plurality of diverse sources. The method also includes translating data represented in a first modeling language to data represented in a second modeling language for storing the data in the second modeling language in a global data model repository. The method also includes automatically generating code to support an external management interface, based on the stored data model in the global repository.

Embodiments can include one or more of the following. The method can include automatically generating system documentation based on the stored data. The generated system documentation can correspond to a code generated implementation. The first language can be structured management information (SMI). The second language can be a vocabulary of extensible markup language (XML). Automatically generating code for the external interface can include automatically generating code to assist in implementation of a command line interface (CLI). Automatically generating code for the external interface can include automatically generating code to assist in implementation of a configuration database. Automatically generating code for the external interface can include automatically generating code to assist in implementation of SNMP subagents. Automatically generating code for the external interface can include automatically generating code to assist in implementation of an API. Modeling operational system data from a plurality of sources can include modeling operational system data from a plurality of sources using at least one of the first language and the second language.

In another aspect, a system includes a global repository, an interface to a plurality of sources, and an interface to an external interface. The global repository is configured to model network element commands, events, and data from a plurality of sources in a common representation. The global repository is also configured to translate data represented in a first modeling language to data represented in a second modeling language for storing the data in the second modeling language in a global data model repository and automatically generate code to support external management interface based on the stored data in the global repository.

Embodiments can include one or more of the following. The system can be configured to automatically generate system documentation based on the stored data. The generated system documentation can correspond to a code generated implementation. The first language can be structured management information (SMI). The second language can be a vocabulary of extensible markup language (XML). The global repository can be configured to model operational system data from a plurality of sources using at least one of the first language and the second language.

In another aspect, a computer program product tangibly embodied in an information carrier, for executing instructions on a processor, the computer program product being operable to cause a machine to model network element commands, events and data from a plurality of sources in a common representation. The computer program product is also configured to translate data represented in a first modeling language to data represented in a second modeling language for storing the data in the second modeling language in a global data model repository. The computer program product is also configured to automatically generate code to support external management interface based on the stored data in the global repository.

Embodiments can include one or more of the following. The computer program product can also be configured automatically generate system documentation based on the stored data. The generated system documentation can correspond to a code generated implementation. The first language can be structured management information (SMI). The second language can be a vocabulary of extensible markup language (XML). The computer program product can be configured to model operational system data from a plurality of sources using at least one of the first language and the second language. The instructions to cause a machine to automatically generate code for the external interface can include instructions to cause a machine to automatically generate code to assist in implementation of a command line interface (CLI). The instructions to cause a machine to automatically generate code for the external interface can include instructions to cause a machine to automatically generate code to assist in implementation of a configuration database. The instructions to cause a machine to automatically generate code for the external interface can include instructions to cause a machine to automatically generate code to assist in implementation of SNMP subagents. The instructions to cause a machine to automatically generate code for the external interface can include instructions to cause a machine to automatically generating code to assist in implementation of an API. The instructions to cause a machine to model operational system data from a plurality of sources can include instructions to cause a machine to modeling operational system data from a plurality of sources using at least one of the first language and the second language.

The representation of network element commands, events and data in a common language provides the advantage of developing a common data model representation for element management systems which is independent of the external interface protocols which may be used to access and manage the network element. An overall data model captured in a single modeling language representation also allows the use of automatic code generation and system document generation for external management interfaces of the network element.

The use of a common data model and code generation provides advantages of consistency across all management interfaces and also allows an architecture where software applications internal to the network element have a single internal application interface that is independent of the transport protocols and syntax of any particular external interface specification (for instance a CLI, SNMP or XML management interface). This reduces development time because common data and access mechanisms are re-used for multiple interfaces. Additionally, since both code and system documentation are generated from a single source, the product implementation and associated documentation is complete and correct.

### DESCRIPTION OF DRAWINGS

FIG. 1 is a block diagram of network elements, objects, and element management systems.

FIG. 2 is a block diagram of a model environment and external interfaces.

FIG. 3 is a block diagram of a data model.

FIG. 4 is a block diagram of the relationships between components of the data model.

### DESCRIPTION

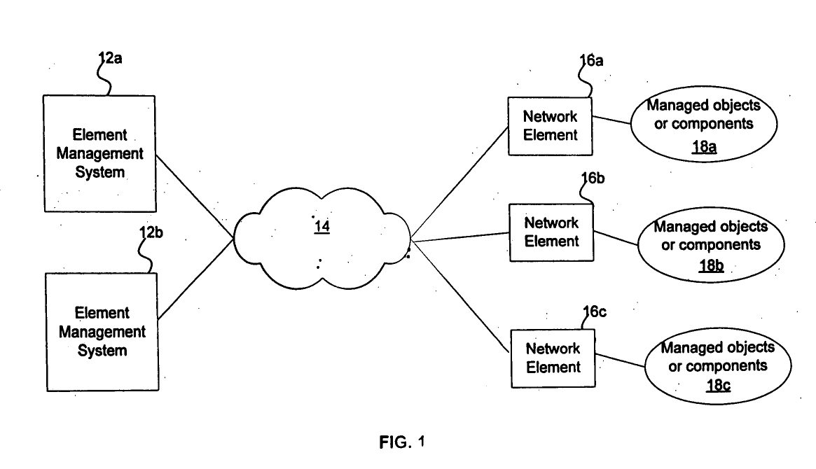

Referring to FIG. 1, a network 10 including a plurality of network elements 16a -16c, each element providing some form of network functionality is shown. The network elements 16a -16 are coupled to element management systems 12a-12b via a network 14. The network elements 16a -16c provide a command line interface (CLI) and possibly additional machine-to-machine management protocols such as Simple Network Management Protocol (SNMP) and Extensible Markup Language (XML) for element management systems 12a-12b. Typically, an element management system is required to manage configuration data, run time status data (e.g., statistics or accounting data), and system event data. A single element management system, e.g., 12a can manage multiple network elements 16a -16c, or multiple element management systems 12a-12c can manage a set of multiple network elements 16a -16c. The network 16a -16c can interface with one or more managed objects or components. For instance, the managed objects or components can include ports on network interface cards, slots within a backplane and others.

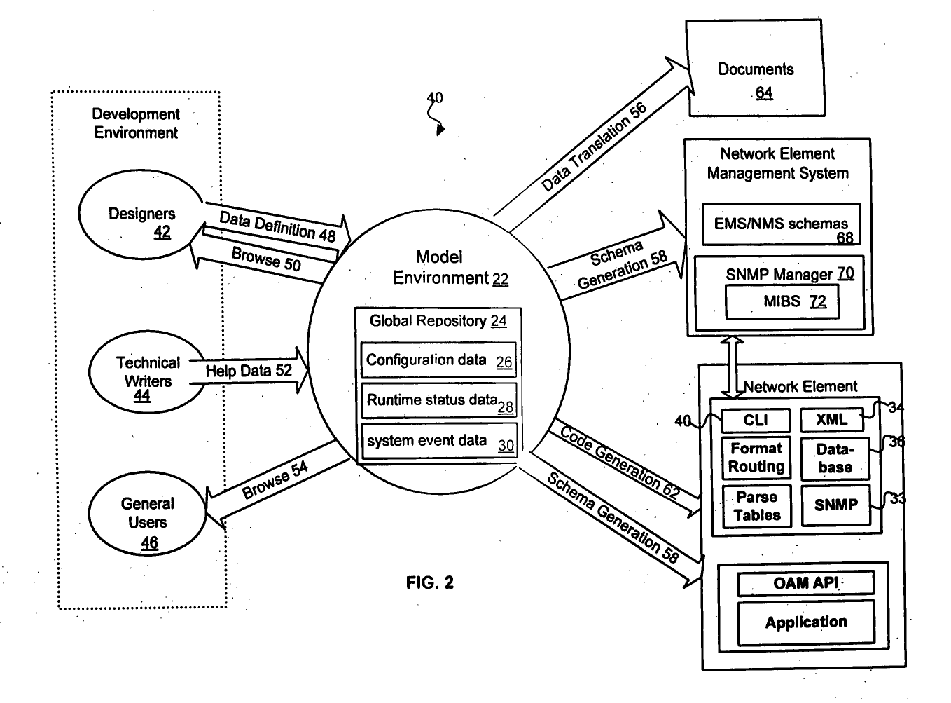

Referring to FIG. 2, a development environment 40 that assists in the development of management interfaces between a development environment and a network element management system, the network elements 16a -16c, and associated system documentation for the network elements is shown. The development environment 40 includes a data model environment 22 that provides a set of tools for developers and documentation primes (e.g., placeholders in the document that are filled in with data during generation) to maintain a global repository 24 for the network element data model. The global repository 24 stores the data model in a single representation using industry standard modeling languages. This single data model representation is used in the development of external management interfaces. External interfaces can include, for example, a command line interface 40, an SNMP interface 33, an XML interface 34, and so forth.

The model environment also can automatically generate software to support development of required network element infrastructures such as a configuration database 36, parsing and formatting routines for commands, events and data specific to any external management interface, and application specific code 38 for managing data, responding to commands, and generating events. The model environment also provides data translation 56 for the generation of system documentation to formally describe the external interfaces. For example, the data model for a network element may model card types that are provisioned into a slot of a network element by commands generated by the model environment.

The data model environment generates code for multiple functions for network applications. For example, the data model environment generates code that allows an application to add, delete, or modify card configuration data in a database. The data model environment can generate parsing and formatting code to support converting the CLI interface commands and responses in the model to an internal representation. The data model environment can also generate parsing and formatting code to support converting the XML interface commands and responses to an internal representation. The data model environment can also generate code to define an internal application programming interface (API) for handling the commands and responses to add, delete or modify card configuration which is independent of the syntax and formatting of the external interfaces.

The data model (maintained in the data model environment 22) is constructed using two industry standard languages: Structure of Management Information (SMI) which is used for modelling SNMP MIBs, and extensible markup language (XML) which is used to define an XML schema necessary to model the components, events, commands and data of the network element data model.

The global repository defines an XML schema capable of representing the elements required to define a network element data model. The XML schema defines documentation elements associated with data model elements to assist in generating on-line and system documentation. The XML schema provides the capability to model commands, responses, and events and any associated command request parameters or options. Commands and events generally operate or report on data classified as either configuration data or operational (run-time) data. The XML vocabulary also allows for the definition of a set of hierarchical components with which configuration and operational data may be associated. For example, the XML vocabulary allows the capture of a set of events such as alarms, accounting records, tracing events, and the associated data for each event. For example, the XML vocabulary allows the capture of a hierarchy of configuration data that are managed by the use of modeled commands.

Many runtime systems (e.g., system 22) use the simple network management protocol (SNMP) as defined by the Internet engineering task force (IETF) to describe the management interface for any particular network element function. SNMP uses a standard modeling language called Structure of Management Information (SMI) to capture data and events used to manage specific functions such as IP routing. An instantiation of the management capabilities for a specific function is called a Management Information Base (MIB) and typically defines the data to be managed as well as the events to be generated using the SMI modeling language. In order to generate a single global data model in the global repository in a standard format and language, the model environment includes software to convert SNMP MIBS into the XML vocabulary. This allows standard IETF MIBs to be easily incorporated into the overall data model, and allows enterprise MIBs to be defined and made part of the SNMP capabilities of the network element. Since the data is stored in a standardized XML format, the data can be referenced to generate commands and events for the external interfaces that share the same data.

A data modeling environment for building network elements and network element systems includes the use of a global data model stored in the global repository. Multiple users can reference and modify the data model in the model environment 22. For example, software developers 46 and documentation writers 44 may both browse and modify the data model in the model environment to meet overall product needs. System designers 42 can also generate data definitions 48 and store the definitions in the model environment. Technical writers 44 generate and store help data 52 in the model environment 22.

From the data in the global repository multiple types of information and interfaces can be generated. The use of code generation 62 from the model environment 22 for the interfaces provides several advantages. For example, the use of a common API for delivery of configuration data, operational data, and event data allows applications to be independent of the syntax and formatting requirements of multiple external interfaces. Since the data is stored in a consistent format and language, the application does not have to be aware of the interface and language in which the data was originally generated. Data and access mechanisms can also be re-used due to the consistency of a common data model across multiple interfaces.

The data in the model environment in combination with the code generation based on the defined XML schema can be used to generate a variety of external interfaces. Data translation 56 of data in the model environment 22 generates system documentation 64. The model environment can also generate schema and code for a network element 32 to implement a command line interface (CLI), an XML interface providing CLI capabilities, a configuration database, and SNMP agents or subagents to support SNMP access. The model environment 22 can also generate application specific code to provide APIs to support configuration, querying, and reporting events in the OAM 74.

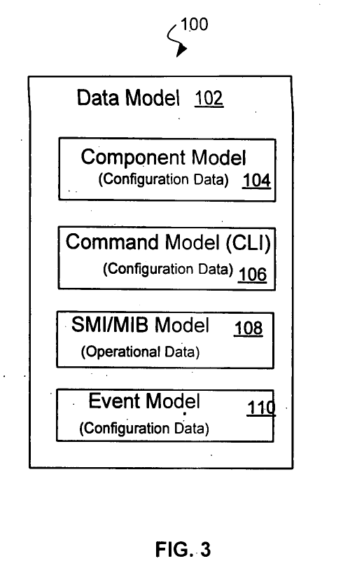

Referring to FIG. 3, the main elements of a global data model are shown. As described above the data is stored in a common representation using an XML vocabulary. The main global data model elements include a component model 104, a command model 106, an SMI model derived from SNMP, SMI, and MIBS 108, and an event model 110.

The component model 104 represents the physical and logical managed entities on the system. Data in the component model 104 is arranged using a hierarchical model. For example, components can contain sub-components. Each component represents physical or logical entities that are managed by the runtime system. The components can be configured or dynamic. A set of rules dictates the behavior of the configured and dynamic components.

Each component in the component model hierarchy may include configuration data attributes that are stored persistently in the network element runtime system. Configuration data is thus, stored using a hierarchical structure as defined by the component model 104. Components are often the targets for commands such as interface queries and debugging routines and events are often reported against components in the hierarchy.

System events may be one of many types and are typically associated with a managed component (e.g., a card or a port). Examples of different event types include alarms and SNMP traps events to report component problems, accounting and statistic events to report counters and service usage statistics for performance monitoring and accounting, as trace events which may be instrumented to trace protocols PDUs for debug purposes.

For example, a routing component may generate alarms when it detects routing problems. Alternately, when configured to support debugging the routing component generates trace events to indicate when the routing table is updated. The generated event is reported against a defined component and includes other data elements as defined in the data model.

The command model 106 fully describes any command request, including command request parameters and modifiers, as well as the responses to the command and its parameters or modifiers. The command model 106 accommodates use of features such as the ability to prompt the user for additional information or confirmation under certain circumstances. Commands are associated with, and executed against components.

For example, a command model 106 may be defined to include a set of commands used by an operator to manage configuration data, a set of commands to query the state and operational data of components, as well as commands to perform operations against components. The responses to user inputs are structured so they can be formatted and viewed in various ways.

The SMI/MIB model 108 describes data accessible using the SNMP protocol, and this same data may be used to generate requests or to show responses to commands. The SMI/MIB model 108 includes queryable operational data (e.g., counters, gauges, statistics, and state data), as well as traps (e.g., autonomous events to be reported by a network element function). Data represented in the SMI/MIB model is accessible using the SNMP protocol (e.g., the SNMP get command) but the date may also be referenced by commands of other external interfaces such as CLI operational show commands or XML interface operational show commands.

The data in the SMP/MIB model 108 is modeled using structure of management information (SMI) language according to IETF standards. Both standard management information bases (MIBs) and enterprise MIBs can be used to represent the data. A MIB is a formal description of a set of network objects that can be managed using the Simple Network Management Protocol (SNMP). The format of the MIB for any defined network element function may be defined as part of the IETF MIB RFCs for SNMP management. There are MIBs (or MIB extensions) for sets of related network entities to be managed. Product developers generate and register new (Enterprise) MIB extensions to provide functionality not expressed in the standard MIBs.

The event model 110 describes types of events such as alarms, traps, accounting, statistics, and trace events. These types of events describe data associated with runtime instance generation of the event. The type model defines the data associated with an event for a component. These events can be modeled by OAM (e.g., carrier grade type fault) or can be modeled by application specific terms (e.g., statistics or accounting). Since the events are modeled events, the system can generate customer documentation corresponding to the types of alarms expected for a system and fields associated with the alarm. The documentation relates to the functionality of the system during operation. The event model defines events and during operation, the system generates instances of the event and populates the instance with a relevant set of data. The instance (including the appropriate data) is then formatted and displayed or distributed in an appropriate readable format. For example, the instance is displayed in a human readable for human viewing and in a form allowing parsing for use by another computer system.

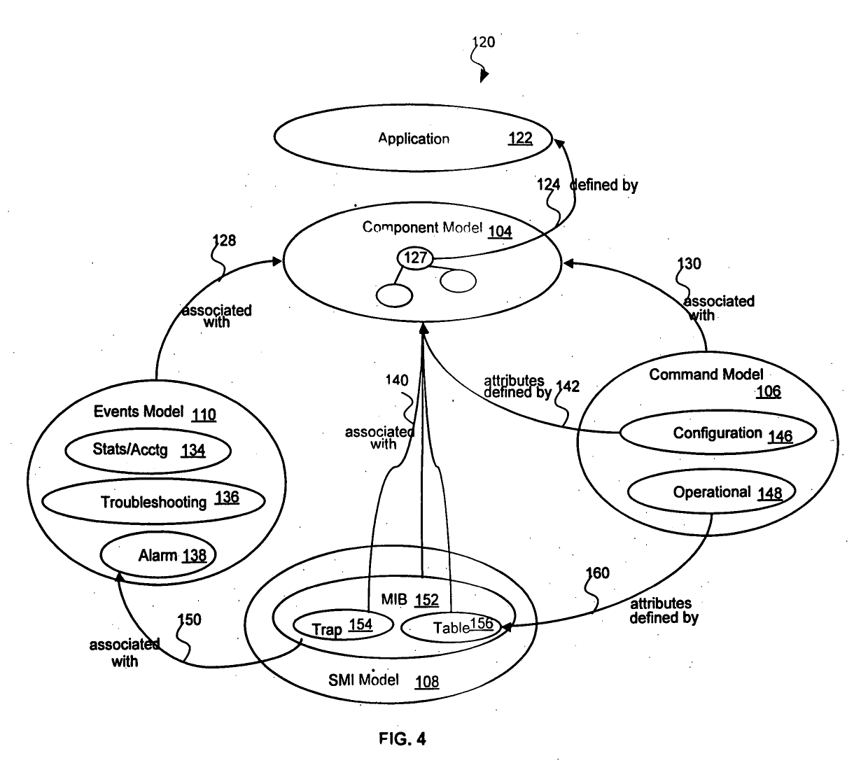

Referring to FIG. 4, a relationship between the four elements included in the data model 102 is shown. The components of the data model 102 are interrelated to provide a consistent, single interface to an application 122. The component model 104 provides an interface to the application 122. The other elements of the data model are directly (or indirectly) linked to the component model 104. The component model 104 above is not depicted at the instance level. Instead, each modeled component is uniquely defined in the component hierarchy 127.

All commands on the system are associated with a modeled component. The association may be with an instance of the class, the sub-tree of an instance of the class, with all instances of a class, or with the sub-trees of all instances of a class. If there is no modeled component to be directly associated with a command, the command is associated with the root of the component model. In addition, a modeled component is able to be associated with multiple commands.

Within the command model 106, configuration commands 146 have attributes defined within the component model 104 (as indicated by arrow 142). Operational commands 148 have attributes defined in the SMI model 108 within a set of MIBs 152 or tables 156 within MIBs (as indicated by arrow 160). SMI elements associated with the command model 106 are also related to the modeled component associated with the command (indicated by arrow 130).

SMI elements (MIBs 152, tables 156, and traps 154) are associated with one or more modeled components (as indicated by arrows 140). Traps 154 can also be associated with an alarm 138. In some examples, if a standard trap is not used (or is replaced by a more extensive enterprise trap), there may be no association. In this example, the trap 154 and associated alarm 138 are linked to the same component in the component model 126.

Events 110 are associated with one or more components in the component model 126 (as indicated by arrow 128). The events can include statistics and accounting 134, troubleshooting 136, and alarms 138.

A number of embodiments have been described. Nevertheless, it will be understood that various modifications may be made without departing from the spirit and scope of the invention. Accordingly, other embodiments are within the scope of the following claims.

1. A method comprising:
modeling in a common representation network element commands, events and data from a plurality of sources;
translating data represented in a first modeling language to data represented in a second modeling language;
storing the data in the second modeling language in a global data model repository; and
automatically generating code to support external management interface based on the stored data in the global repository.

2. The method of claim 1 further comprising automatically generating system documentation based on the stored data.

3. The method of claim 2 wherein the generated system documentation corresponds to a code generated implementation.

4. The method of claim 1 wherein the first language is structured management information (SMI).

5. The method of claim 1 wherein the second language is extensible markup language (XML).

6. The method of claim 1 wherein automatically generating code for the external interface includes automatically generating code in implementation of a command line interface (CLI).

7. The method of claim 1 wherein automatically generating code for the external interface includes automatically generating code in implementation of a an Extensible Markup Language interface.

8. The method of claim 1 wherein automatically generating code for the external interface includes automatically generating code in implementation of a Simple Network Management Protocol interface.

9. The method of claim 1 wherein automatically generating code for the external interface includes automatically generating code in implementation of a configuration database.

10. The method of claim 1 wherein automatically generating code for the external interface includes automatically generating code in implementation of Simple Network Management Protocol subagents.

11. The method of claim 1 wherein automatically generating code for the external interface includes automatically generating code to assist in implementation of an Application Program Interface.

12. The method of claim 1 wherein modeling operational system data from a plurality of sources includes modeling run-time system data from a plurality of sources using at least one of the first language and the second language.

13. A system comprising:
a global repository;
an interface to a plurality of sources; and
an interface to an external interface, with the global repository is configured to:
model in a common representation network element commands, events and data from a plurality of sources;
translate data represented in a first modeling language to data represented in a second modeling language;
for store the data in the second modeling language in the global data model repository; and
automatically generate code to support external management interface code development based on the stored data in the global repository.

14. The system of claim 13 further configured to automatically generate system documentation based on the stored data.

15. The system of claim 14 wherein the generated system documentation corresponds to a code generated implementation.

16. The method of claim 13 wherein the first language is structured management information (SMI).

17. The method of claim 13 wherein the second language is extensible markup language (XML).

18. The method of claim 13 wherein the global repository is further configured to model operational system data from a plurality of sources using at least one of the first language and the second language.

19. A computer program product, tangibly embodied in an information carrier, for executing instructions on a processor, the computer program product being operable to cause a machine to:
model in a common representation network element commands, events and data from a plurality of sources;
translate data represented in a first modeling language to data represented in a second modeling language;
store the data in the second modeling language in a global data model repository; and
automatically generate code to support external management interface code development based on the stored data in the global repository.

20. The computer program product of claim 19 further configured to automatically generate system documentation based on the stored data.

21. The computer program product of claim 20 wherein the generated system documentation corresponds to a code generated implementation.

22. The computer program product of claim 19 wherein the first language is structured management information (SMI).

23. The computer program product of claim 19 wherein the second language is extensible markup language (XML).

24. The computer program product of claim 19 wherein the global repository is further configured to model operational system data from a plurality of sources using at least one of the first language and the second language.

25. The computer program product of claim 19 wherein the instructions to cause a machine to automatically generate code for the external interface include instructions to cause a machine to automatically generate code implementat a command line interface (CLI).

26. The computer program product of claim 19 wherein the instructions to cause a machine to automatically generate code for the external interface include instructions to cause a machine to automatically generate code to implementata configuration database.

27. The computer program product of claim 19 wherein the instructions to cause a machine to automatically generate code for the external interface include instructions to cause a machine to automatically generate code to implement SNMP subagents.

28. The computer program product of claim 19 wherein the instructions to cause a machine to automatically generate code for the external interface include instructions to cause a machine to automatically generating code implement an API.

29. The computer program product of claim 19 wherein the instructions to cause a machine to model operational system data from a plurality of sources include instructions to cause a machine to modeling operational system data from a plurality of sources using at least one of the first language and the second language.
